(19) United States
(12) Patent Application Publication
(10) Pub. No.: US 2006/0274166 A1
(43) Pub. Date: Dec. 7, 2006

(54) Sensor activation of wireless microphone

(76) Inventors: Matthew Lee, Chapel Hill, NC (US); Ich-Kien Lao, Raleigh, NC (US); William Bradford Silvernail, Raleigh, NC (US); Ray C. Henry, Wake Forest, NC (US); Randy Martinez, Burlington, NC (US)

Correspondence Address: John L. Sotomayor, Suite 300, 511 Davis Drive, Morrisville, NC, 27560, US

(21) Appl. No.: 11/327,458

(22) Filed: Jan. 9, 2006

Related U.S. Application Data
(60) Provisional application No. 60/685,794, filed on Jun. 1, 2005.

(51) Int. Cl. H04N 5/76

(52) U.S. Cl. 348/231.99

(57) ABSTRACT

A wireless microphone attached to a ruggedized, mobile digital video recording system may be used to record audio of events when activated. To conserve file space in a storage device, a sensor may be used to activate the microphone for audio recording, and to cause video recording to begin at the same moment through a pairing mechanism between the wireless microphone and the mobile digital video recording system. This sensor activation provides a complete audio/visual record of the event, or series of events, that caused the sensor to trigger. The microphone may also be manually triggered, thus providing a user with a means to capture audio/visual records in an ad hoc fashion. All recorded events are saved to files in a high-capacity storage device for later retrieval and review.

### PRIORITY

This application claims priority from co-pending application 60/685,794 filed May 31, 2005.

### TECHNICAL FIELD

The present invention is directed to a wireless microphone attached to a mobile digital information monitoring and recording system that records and stores audio, video, and meta-data. In particular, the present invention is directed to the activation of a separable, audio device in the form of a self-contained microphone in wireless communication with the mobile digital information system and activated to use by a sensor external to or button attached to the wireless microphone.

### BACKGROUND

Public safety systems that record and store a video record of events are enhanced by the capture of an audio record of those same events. Digital video recorders provide the capability to record both audio and video for any given event. A problem arises, however, in managing the storage system to provide enough storage capacity for full time video and audio recording of all events. In addition, searching through hours or even days of stored video and audio seeking a single audio event is time consuming and tedious, and, therefore, highly prone to error.

One solution is to provide the video recordation system with the ability to begin recording only upon the receipt of trigger events. Trigger events are actions that signal to the digital video recorder system that recording must begin in order to capture a record of the activity that necessitated the trigger event. Digital video recorder systems, such as that described in U.S. Pat. No. 6,831,556 (Boykin et al) which is herein incorporated by reference, disclose system level triggers that activate video and audio recording. However, there still remains an issue of activating video recording such that the video and audio recording will be synchronous for future evidentiary use. When a user wants to begin recording an event based upon an audio trigger, or beginning an audio recoding of an event when the video recording camera is off or incapacitated but the audio recoding device, in the form of a wireless microphone, is still operational.

The invention disclosed is an innovative means for initiating a synchronous audio, video, and metadata recording of actions as needed based upon an activation event from a wireless microphone using either manual means or through the receipt of a trigger event. The instant invention has the advantages of extending the performance of a mobile digital video recording system, collecting and storing an integrated data stream for evidentiary use, and extending the storage life of a high capacity storage device.

### SUMMARY OF THE INVENTION

This invention is directed to a mobile digital video and audio recorder system in which the video and audio record is saved to disk as the result of actions that serve as trigger events for the system. The system contains a wireless microphone to record audio information during events that are deemed of interest to a user of the system. The wireless microphone may also be paired to the mobile digital video recording system such that the wireless microphone will only communicate to and from the system with which it is paired. This invention may be used in any mobile environment that is deployed to a vehicle in the field. A preferred embodiment of this invention is a system deployed within a police or security patrol car in which the user is an officer with the need to record video and audio of events for evidentiary purposes.

The system deployed within a patrol car has a finite storage capacity that necessitates the conservation of storage space. For this reason, during normal patrol activities the wireless microphone is set to audio standby and the integrated data stream is not permanently stored to the High Capacity Storage (HCS) device installed in the patrol vehicle. The system stores an ongoing data buffer of user configurable length, up to 180 seconds, in the HCS. This data buffer is a circular buffer and is continuously overwritten unless the system is activated through manual or automatic means, whereupon the circular data buffer is non-destructively stored to an integrated data stream file within the HCS.

When an action that is defined as a trigger event occurs, the patrol officer may activate audio and video recording by manually depressing a button on the surface of the wireless microphone or recording may be activated by a trigger such as the activation of the siren on, light panel, crash detector, over speed detector, door open detector, or other user definable trigger that causes an input process such as input from a General Purpose Input/Output (GPIO) processor, RS-485 port, RS-232 port, USB or other I/O port to initiate audio, video, and metadata recording to the HCS.

At the beginning of the recording an event timer is set to a preconfigured length of time. The event timer is set as a precaution to end recording such that the recorded integrated data stream does not fill all available storage within the HCS should the driver of the vehicle not turn off recording manually. At the end of this time period, or when recording is terminated manually, the wireless microphone is once again returned to an audio standby status.

### BRIEF DESCRIPTION OF THE DRAWINGS

FIG. 1—System flow: this diagram is a system level description of the process flow of the invention.

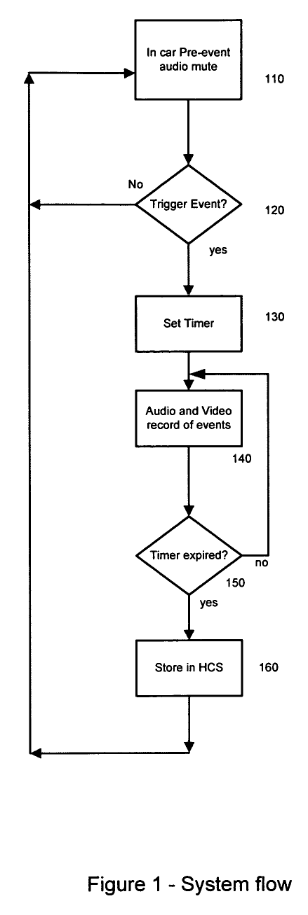

FIG. 2—System Diagram: Equipment and communications presents a connection diagram for communications pathways for the system equipment.

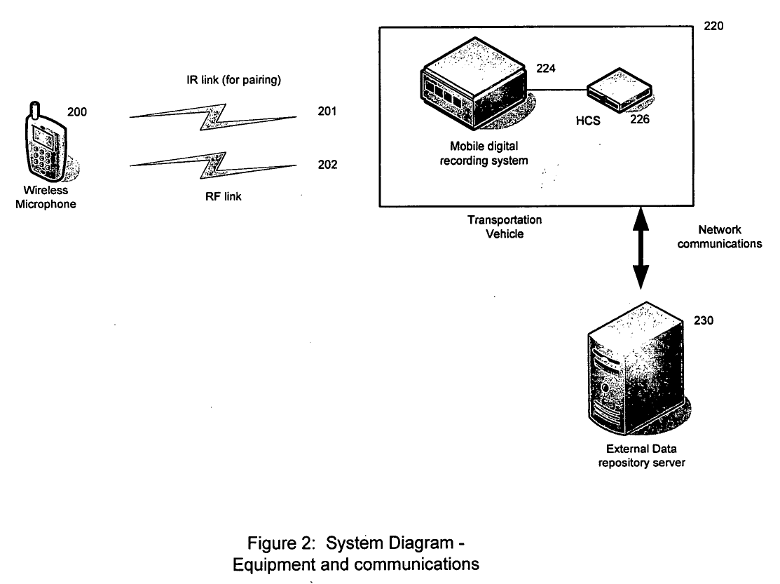

### DETAILED DESCRIPTION

In this invention a wireless microphone 200 is connected to a mobile digital video recorder system 224 as an audio input device, recording audio to be synchronized with video data captured by the system. The microphone 200 is connected through the use of wireless connectivity means such as IEEE 802.11b, IEEE 802.11g, Bluetooth, or other proprietary and non-proprietary means 202, as well as a short-range Infrared link 201. The microphone 200 itself is a separate, stand-alone component that consists of the audio capture functionality and a button located on the exterior of the microphone case to provide a user with the ability to initiate synchronous audio, video and metadata capture upon depressing the button.

Infrared Pairing Activation: Each wireless microphone 200 and Mobile Digital Video Recorder (MDVR) 224 contain infrared transceivers capable of sending and receiving pairing data using an optical infrared transceiver link 201. The wireless microphone 200 and MDVR 224 infrared transceivers have a limited range of about 1 meter, and about 30 degrees of visible width. This feature is used to address several of the limiting issues that exist when using a radio frequency (RF) wireless over-the-air pairing system. These issues include: (1) initiating the pairing activation by pressing a button on the wireless microphone 200 to locate the nearest MDVR 224 unit with which to be paired and initiate pairing activity; (2) the risk of a security breach due to eavesdropping that exists when sending pairing data over an RF link; and (3) interference from multiple simultaneous pairing operations that could be occurring in or near adjacent vehicles. A short range two-way infrared data link 201 is used to address these issues. The pairing process is accomplished via the following steps: (1) the wireless microphone 200 infrared transceiver window is aimed at an MDVR 224 infrared transceiver window; (2) the pairing button is pressed on the wireless microphone 200; (3) the wireless microphone 200 sends its RF wireless address and pairing information 201 to the MDVR 224; (4) the MDVR 224 confirms receipt of the pairing information from the wireless microphone 200, and replies to the wireless microphone 200 with the MDVR 224 RF wireless address and pairing information; and (5) the wireless microphone 200 and the MDVR 224 will then only pair to addresses exchanged over that infrared link.

The pairing process of the present invention occurs over infrared rather than via an RF radio link. RF-based wireless pairing systems are also susceptible to eavesdropping and intrusion if a third party can intercept the pairing information from the RF radio link during the pairing process. A short range, narrow width, infrared-based system of the present invention dramatically reduces the range at which such pairing data can be intercepted. A third party seeking to intercept such pairing data would also need to greatly increase the complexity of their system to include RF and optical reception and transmission techniques. The infrared exchange also eliminates having multiple wireless microphones 200 linking to other wireless microphone 200 or MDVR 224 units if several units are pairing at the same time. A short range of about one meter prevents address and system information from leaving the immediate vicinity of a vehicle and unintentionally pairing with another unit.

Once paired, the wireless microphone 200 is activated through a mobile digital video recorder 224 by depressing the manual record button on the microphone 200 or automatically through a contact closure, which sets a control voltage low condition, or a relay closure that sets a control voltage high condition, depending upon the system hardware configuration. Event conditions that can result in a contact or relay closure include siren on, lights on, door open, over speed, crash sensor or any event that a user determines should be configured as a triggerable event, that has a result or action that can be measured, and for which a trigger threshold may be established for activation through an established I/O means. This contact closure may also be performed manually by a user pressing a button on the surface of the microphone enclosure which activates the wireless microphone and serves as a trigger event. Whenever a trigger event occurs, the I/O means requests the MDVR system 224 to begin recording the video, audio and metadata.

In this embodiment, prior to manual or trigger event activation, the wireless microphone 200 is set in pre-event audio standby status 110. This status is the normal operational mode for the wireless microphone 200 and the microphone 200 is maintained in this status until a trigger event occurs. The pre-event audio standby 110 status allows the data stream recording to remain free from audio recorded data that is not directly related to an official activity.

Upon the receipt of a trigger event 120, the wireless microphone 200 begins recording audio data and initiates the transfer of recorded video data from a circular data buffer to an on-board High Capacity Storage (HCS) device 226. The audio and video data streams are recorded to the HCS 226 with embedded timestamp information to allow later synchronization between the video data and its associated audio data. At the same time, a record timer is set 130 to provide a finite period of time for data recording to the HCS 226 in the event that the vehicle operator neglects to turn off recording manually. This record timer is pre-configured to a time period of user configurable length, and may be terminated manually by a user prior to the expiration of the timer 150.

The integrated data stream is recorded 140 to the HCS 226 for the duration of a time period marked by the manual termination of recording or the expiration of the record timer. Upon manual termination or expiration of the record timer 150, the video data is re-routed back to the circular data buffer and the wireless microphone is once again placed into pre-event audio standby 110 status. During the time that the integrated data stream is being collected, the stored integrated data stream files are asynchronously transferred to file storage 160 on the HCS 226. Upon returning to a maintenance, or other designated, facility, the HCS 226 may be physically removed from the patrol vehicle and the integrated data stream files are saved to a system server 230, or the integrated data stream files may be transferred through a wired or wireless communication channel to said system server 230. The downloaded files may then be reviewed at a later time.

While this invention has been particularly shown and described with reference to preferred embodiments thereof, it will be understood by those skilled in the art that various changes in form and details may be made therein without departing from the spirit and scope of the invention as defined by the appended claims.

We claim:

1. A process for the synchronous activation of audio data capture through the use of a wireless microphone and video data capture through the use of a video camera comprising the steps of:
a) initializing a wireless microphone;
b) performing a pairing activation activity for said wireless microphone;
c) polling a plurality of input devices to determine if a trigger event has occurred;
d) upon the occurrence of a trigger event,
i. changing the state of the wireless microphone from standby to record,
ii. recording audio data from the wireless microphone,
iii. simultaneously recording video data from a camera associated with the wireless microphone,
iv. also simultaneously recording metadata captured by a plurality of input devices,
v. and setting a user configurable timer to define the upper limit for the duration of the recording for said trigger event;
e) associating configuration data with the audio and video recorded data;
f) upon expiration of the event timer, or a manual reset of the system,
i. returning to step a and repeating steps a-e,
ii. storing integrated data stream files into file space within the HCS;
g) wherein the audio and video data recorded are available to a user for later review and analysis of events captured by the audio and video devices of the system to provide for increased public security.

2. A process for the activation of audio data capture through the use of a wireless microphone as recited in claim 1 further comprising:
wherein the initialization of said wireless microphone comprises placing said wireless microphone in standby mode.

3. A process for the activation of audio data capture through the use of a wireless microphone as recited in claim 1 further comprising:
wherein the step of polling comprises a dynamic interrogation of status of all input/ouput devices by a mobile digital video recorder processor.

4. A process for the activation of audio data capture through the use of a wireless microphone as recited in claim 1 further comprising:
wherein the trigger event comprises a manual activation or contact or relay closure from any one of a plurality of events that includes siren on, lights on, door open, over speed, crash sensor or any event that a user determines should be configured as a triggerable event in said processor.

5. A process for the activation of audio data capture through the use of a wireless microphone as recited in claim 1 further comprising:
wherein the step of associating configuration data comprises associating timestamp data with the captured audio, video and metadata.

6. A system for the activation of data capture including a wireless microphone for audio data capture through the use of said wireless microphone and a video camera for capturing video data comprising:
a) setting a wireless microphone to an initial state;
b) pairing said wireless microphone with an MDVR;
c) polling a plurality of input devices to determine if a trigger event has occurred;
d) upon the occurrence of a trigger event, changing the state of the wireless microphone from standby to record, recording audio data from the wireless microphone, recording video data from a camera associated with the wireless microphone, and setting a user configurable timer to define the duration of the recording for said trigger event;
e) associating synchronization data with the audio and video recorded data;
f) recording said captured audio and video data to an HCS;
g) and resetting the system to an initial state upon manual reset or the conclusion of the time period set by said configurable timer.

7. A system for the activation of data capture including a wireless microphone for audio data capture through the use of said wireless microphone and a video camera for capturing video data wherein setting said wireless microphone to an initial state as recited in claim 6 further comprising:
placing said wireless microphone in standby mode.

8. A system for the activation of data capture including a wireless microphone for audio data capture through the use of said wireless microphone and a video camera for capturing video data as recited in claim 6 further comprising:
wherein polling comprises a dynamic interrogation of all triggers by a mobile digital video recorder processor.

9. A system for the activation of data capture including a wireless microphone for audio data capture through the use of said wireless microphone and a video camera for capturing video data wherein the trigger event as recited in claim 6 further comprising:
a contact or relay closure from any one of a plurality of events that includes siren on, lights on, door open, over speed, crash sensor or any event that a user determines should be configured as a triggerable event in said processor.

10. A system for the activation of data capture including a wireless microphone for audio data capture through the use of said wireless microphone and a video camera for capturing video data wherein associating configuration data as recited in claim 6 further comprising:
associating timestamp data with the captured audio and video data.
